(19) United States
(12) Patent Application Publication
(10) Pub. No.: US 2010/0105017 A1
(43) Pub. Date: Apr. 29, 2010

(54) CENTRAL CONTROL FOR WEB-BASED HEALTH CARE TRAINING

(75) Inventor: Rainer Herden, Bammersdorf (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/607,117

(22) Filed: Oct. 28, 2009

(30) Foreign Application Priority Data
Oct. 28, 2008 (DE) 10 2008 053 469.2

(51) Int. Cl. G09B 19/00; G09B 23/00

(52) U.S. Cl. 434/219; 434/262

(57) ABSTRACT

A computer-implemented method and system centrally control web-based training courses for a plurality of staff members in a medical institution. A set of different training courses is accessible via an internet interface and a set of different job descriptions for the staff members. Each job description is assigned to a subset of training courses. The subset of training courses refers to training courses, which have to be completed by the staff member and which are indicative of a qualification of the staff member. For each staff member it is recorded which training courses he already has completed successfully and which training courses he still has to take, taking into account the assigned subset of training courses for his job description, which are provided as a suggestion for training courses to be taken by the staff member.

### CROSS-REFERENCE TO RELATED APPLICATION

This application claims the priority, under 35 U.S.C. §119, of German application DE 10 2008 053 469.2, filed Oct. 28, 2008; the prior application is herewith incorporated by reference in its entirety.

### BACKGROUND OF THE INVENTION

### Field of the Invention

The present invention generally relates to a computer implemented technique for controlling web-based training courses for staff members of an institution, like a hospital, a network of hospitals or a network of medical practitioners and the like.

Institutions and organizations heavily rely on the practical and educational skills of their members to promote their goals and increase quality, productivity and efficiency. In a hospital, usually different professionals work together, who generally have different professional skills and education. For example, a clinic needs assistants from several professionals like nurses, surgical nurses, physicians, consultants, medical specialists like anesthesiologists, internists, surgeons, otologists etc.

For these different professions and qualifications also different training or requirements for certifications are necessary. A specific sequence of courses or trainings has to be taken for a specific job. Normally, this set of trainings is the same for several institutions. However, it also might be possible that each institution has different requirements for training, so that a first clinic has other requirements for certification than a second clinic.

Within huge organizations or clinical departments the controlling of the professional skills of the staff member is a complex task. Controlling here refers to the control and assigning of training courses to an employee and to retrieve information for answering questions. Such questions are:

What kind of training is relevant for employee A?

Which training has employee A has already passed?

Which training has employee A has still not completed up to now?

Is there an employee in another institution who already has passed training “1” and training “4”?

When employee A has to take part in training 2?

Are there any alternatives for participating training “4” for employee A, and if yes, what alternatives do exist?

Up to now it was not possible to control the professional skills of all staff members centrally and automatically. If at all the professional skills and trainings which had been taken by a staff member have only been detected manually and further there was no central controlling of these trainings.

Another aspect has to be seen in the fact that modern hospitals are globally organized, with many representatives located in diverse geographic regions and work by means of local clients which are electronically coupled. To ensure a uniform monitoring of educational skills of the staff members, it is necessary to provide a central controlling of training courses.

Moreover, another aspect has to be seen in the fact that it is necessary to analyze job related information for the staff members, which might be stored in different databases or repositories. In this regard there is a need for accessing different databases and repositories with staff member related and/or training related information.

### SUMMARY OF THE INVENTION

It is accordingly an object of the invention to provide a central control for web-based health care training which overcome the above-mentioned disadvantages of the prior art methods and devices of this general type. Accordingly, the present invention is a computer implemented system and method for centrally controlling web-based training courses for at least one of a plurality of staff members, wherein each of the staff members has a job description within at least one of a plurality of institutions, like a hospital, a business unit or an authority.

With the foregoing and other objects in view there is provided, in accordance with the invention a computer-implemented method for centrally controlling web-based training courses for at least one of a plurality of staff members. Each of the staff members has a job description within at least one of a plurality of institutions. The method contains the steps of: providing a set of different training courses, accessible by a staff member via an Internet interface; providing a set of different job descriptions for the staff members; and assigning a subset of training courses to the job description, which have to be completed by the staff member with the job description. The assigning is based on the institution-specific guidelines. The following steps are automatically executed for controlling the training courses for at least one of the plurality of staff members: recording the training courses which already have been completed successfully by the staff member; matching recorded training courses with the subset of training courses assigned; and deducing a suggestion of training courses to be taken by the staff member.

According to a preferred embodiment of the present invention the system refers to a client-server architecture, in which a plurality of clients is electronically coupled to at least one server. The server is used for accessing the data. Further, the server might be used for running the computer implemented method according to the invention. The web-based training might be accessible by the clients. According to another embodiment of the invention it is possible that the computer implemented method might be executed on a client as well.

The training includes web-based courses or e-learning courses accessible via a website by the user, who might select a specific training and who might interact with the server in this respect.

The method and the system according to the invention include:

a) providing a set of different training, accessible by the staff member via an internet interface, like a browser;
b) providing a set of different job descriptions for the staff members indicative of their professional degree and their professional status within the institution; and
c) assigning a subset of trainings to a job description, which have to be completed by the staff member with the job description, wherein the assigning is based on institution-specific guidelines.

For centrally controlling web-based training the following steps are executed automatically for controlling the training for at least one of the plurality of staff members:

a) recording of training, which already have been completed successfully by the staff member;
b) matching the recorded training with the assigned subset of training; and
c) deducing a suggestion for training to be taken by the staff member.

The present invention has the now described advantages. All training for all staff members are detected and controlled automatically and centrally. All trainings are detected automatically, so that it is possible to generate a staff members' specific qualification profile. It is possible to calculate costs and other investments with respect to the trainings in the past and in the future. It is possible to detect training deficiencies automatically. The content of the trainings might be adapted dynamically with regard to modifications in institutional guidelines or with respect to governmental guidelines or with respect to taking over another job. All information, like documents and presentations are accessible locally on a user's client via web interface (like a web browser). Thus it is not necessary that the user installs a complex computer program on his computer. It is possible to use trainings from other institutions in order to share knowledge.

In the following there is given a short explanation of the terms used in this application.

Web-based trainings refer to E (electronic)-learning courses or units, which are accessible via the internet and refer to a specific job situation. Within the medical domains, for example a medical specialist needs to pass a specialists medical training after graduating from university. In another area for example a manager needs to pass several courses for being able to do his job.

The term “staff members” refers to all users and employees of the computer implemented method within an institution. As already mentioned above, an institution might be a hospital or a business unit or another authority. The group of staff members is not restricted to a specific profession and—in the medical domain—might be related to administrative staff, physicians, nurses and all members of a hospital.

Each job within the institution has a specific job description. Further, there is provided a subset of training which relates to a specific job description. For example the trainings A, B and C have to be passed for being a medical specialist, whereas the trainings U and V have to be completed for being a surgical nurse.

Accordingly, the assigning of a subset of trainings to a job description is based on institution-specific guidelines or might be based on guidelines not limited to any one institution. In case the guidelines change, the assigning is automatically amended and adapted.

According to the invention the recorded trainings, which already have been successfully completed by the staff member are matched with the assigned subset of trainings according to the guidelines. Afterwards a suggestion is deduced automatically for trainings to be taken by the staff member. This suggestion contains the name of the trainings, the time or time period for these trainings and optionally might contain further Meta-information with respect to the trainings to be taken by the staff member. Further information for example might refer to the training material the requirements for the training, which again might refer to other trainings to be passed successfully.

According to an aspect of the invention suggestion X is accessible by a plurality of the clients after authentication or authorization of the client. This leads to the advantage that there is no misuse of information, so that only those clients might access this information, which have been authorized successfully.

According to another aspect of the present invention the method and the system includes monitoring. This monitoring refers to the training status of the staff member with respect to his job description and/or with respect to the subset of trainings having been assigned to him. The monitoring is indicative of the information if all necessary trainings have already been successfully completed by the staff member with his job description. In case the staff member needs to graduate further trainings, it is possible to remind the staff member. According to other embodiments of the invention it is also possible to remind and inform other units of the institutions, like human resource institutions. Further it is possible to issue a non-execution message by the central server in order to indicate that several trainings have not been completed successfully. In this respect it has to be mentioned that the professional degree and the professional status both might be of different kind: first it might refer to the actual degree or status and second it might refer to the future degree or status. For example, a physician actually has job description D and degree/status S and already has passed successfully trainings “1” to “5”, but he wants to qualify for a higher degree as a medical specialist in the future. Therefore, it is required to further pass trainings “6” to “10”. The developing and progress of the physician's qualification status could thus be controlled automatically and efficiently.

According to another embodiment of the present invention it is possible to incorporate the suggestion for trainings which still have to be taken by the staff member into an electronic personal calendar, so that the staff member automatically will be reminded.

According to an aspect of the present invention mandatory trainings are processed separately and independently of optional trainings. Mandatory trainings have to be attended by the staff member for the specific job description, whereas optional trainings are no requirement for the job description and staff member might participate in such an optional training voluntarily.

According to another aspect of the present invention there is provided a browser interface for all staff members in order to book, administer and/or to participate the trainings to be taken by him. This has the advantage that a staff member might log into the system wherever he wants to, so that he is not required to use a specific computer. The only requirement for him is that he has to input his authorization parameters, in order to check his login data to prevent misuse of the system. According to another aspect of the invention further security features might be incorporated into the system, for example encryption methods and further authenticating methods.

Other features which are considered as characteristic for the invention are set forth in the appended claims.
Although the invention is illustrated and described herein as embodied in a central control for web-based health care trainings, it is nevertheless not intended to be limited to the details shown, since various modifications and structural changes may be made therein without departing from the spirit of the invention and within the scope and range of equivalents of the claims.
The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic diagram of a system for centrally controlling web-based trainings for a plurality of staff members within an institution according to the invention; and

FIG. 2 is a block diagram of instances of the system and the method according to the invention.

### DETAILED DESCRIPTION OF THE INVENTION

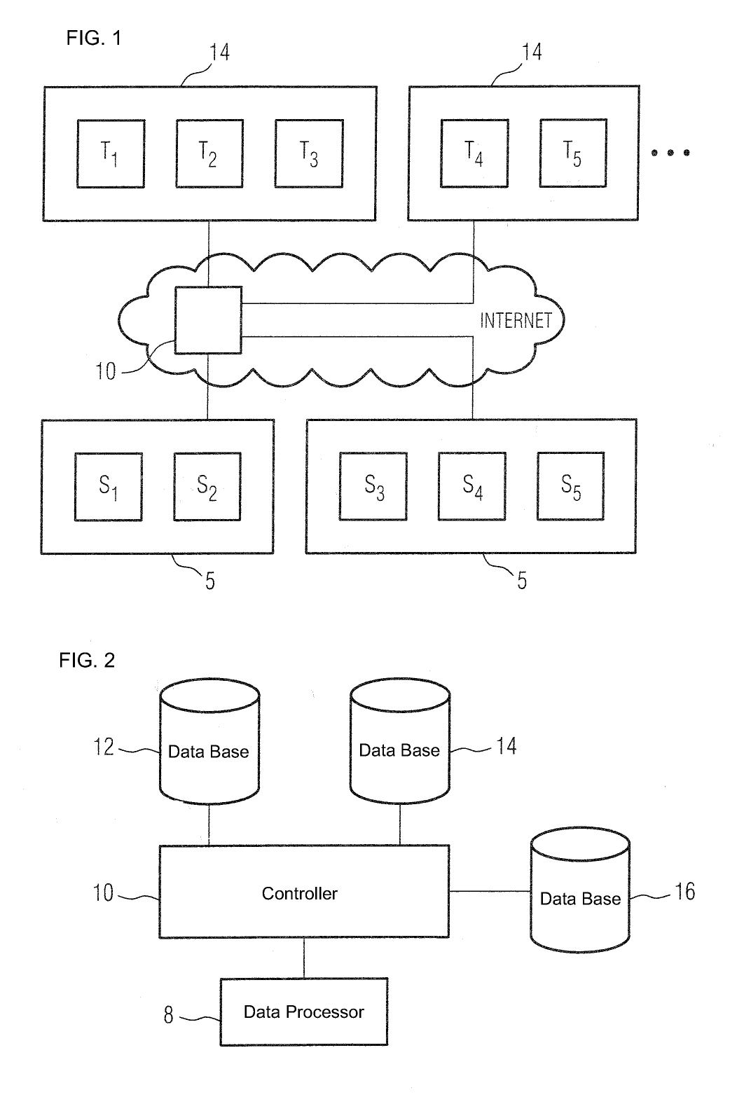

Referring now to the figures of the drawing in detail and first, particularly, to FIG. 1 thereof, there is shown an embodiment of a system for use with a method for centrally controlling web-based training courses (trainings) T₁, T₂, T₃, T₄, T₅, . . . for at least one of a plurality of staff members S₁, S₂, S₃, S₄, S₅, . . . is illustrated. One staff member S or a group of staff members S is assigned to an institution, like a hospital or a network of physicians or a network of healthcare providers, wherein the institution is depicted in the figures with reference numeral 5.

The system and the method according to the invention normally are used within a healthcare system, so that the staff members S are physicians, nurses and the like. However, it is also possible to apply the present invention to other domains, like business units, industrial companies, and administrative offices. The content of the web-base training courses T is thus dependent on the kind of the institution 5. In the healthcare domain the web-base training courses T might also be grouped into web-based training courses which are provided for specific professions in the clinic. Thus, there are web-based trainings T for nurses, for surgical nurses, for physicians in their specific field of profession.

The web-based trainings T typically contain at least one E-learning unit which refers to one or more knowledge items for the specific job description. A learning unit might be subdivided into courses and sub-courses. A web-based training T usually contains data in different formats, like text format, which might be supplemented by illustrative figures, graphics, animation, audio clips, video clips and other data. Typically, there are different categories of data formats: text data, speech data, video data and other audio data. According to a preferred embodiment of the invention the web-based trainings T are stored in databases and repositories 14, as can be seen in FIG. 1. The repositories 14 might be assembled in one single database or might be held and stored in different databases, in a distributed system or in client-server architecture.

One key aspect of the present invention is a controller or controlling instance 10 which is a central instance for processing data with respect to all web-based trainings T for all staff members S. In this system all units and instances are computer-based and are accessible via a web interface via the internet. In other embodiments other networks might be used instead of or in addition to the internet, like an intranet or other private networks. The controller 10 is adapted for automatically controlling all web-based training courses T for the staff members S.

The web-based trainings T might refer to E-learning sources, wherein their content is structured in different modules, courses and sub courses, so that the content might be adapted easily to be aligned with an amended situation within the hospital. For example, the content might be adapted as newly created trainings T might be added or in that different categories of the same content might be provided for example in order to adapt to different learning styles of the learners.

The web-based trainings T might be generated by different technologies, so that a browser (including plug-in applications) is able to interpret and display the appropriate file formats (as mentioned before: speech, text and the like) within each knowledge item. In this respect markup languages (such as HTML, SGML, Dynamic HTML or XML) and/or FLASH, FLASH.RTM might be used.

There are several kinds of users of the system: the trainee, who is the staff member S and who wants to participate in a web-based training T, an administrator, who might be responsible for generating and aggregating the content for the web-based trainings T and might implement the access rights for the respective staff members S and a controller who controls the sequence of trainings T, which are taken by a specific staff member S, in order to indicate his performance and educational level. All users might log in to a computer, which contains a display device, like a monitor or a video monitor, a processor, an input device such as a keyboard or a mouse, a modem, an audio device such as a microphone, a video recording device such as a web camera and interfaces for communicating with the other modules and instances of the system according to the invention. The computer of the user is connected to a network, which in FIG. 1 is depicted as internet via a telecommunication link. The computer may access the internet directly or may be operatively connected to a local area network (LAN) or to another wide area network (WAN), so that all information and data can be transmitted between the specific users and the databases and repositories and the central controller 10.

For a person skilled in the art it is clear that the method according to the method claims is performed by the processor in the computer. The functionality of the computer program is described in the foregoing method. However, it is also possible, to implement this code in hardware. In this case the functionalities of the modules are implemented in hardware and the respective modules are interconnected via interfaces.

According to the invention there is also provided a computer readable medium containing a computer program that is executable by a processor to perform the method according to at least one of the claimed methods.

The structural dependencies between the respective units of the systems are depicted in more detail in FIG. 2 which is described hereinafter. A central unit is the controller 10 which is interconnected to a staff data repository 12, a training data repository 14, a guideline repository 16 and a data processing device 8 of the staff member S. As mentioned above, the data processing device 8 might be a personal computer, a mobile device, like a Smartphone, a telephone with internet access, a laptop or a desktop computer.

According to one embodiment of the present invention the controller 10 is provided with a separate computer and a separate display unit in order to directly work with this computer having input and output devices for user interaction. According to another embodiment of the invention it is also possible to access the controller via the data processing device 8 via a web browser interface and physical links to the controller 10 and optionally to the other repositories 12, 14, 16.

In FIG. 2 there is only depicted one data processing device 8. However, for a skilled person in the art it has to be construed that there is provided a plurality of data processing devices 8 for the plurality of staff members S and/or for the users of the web-based trainings T and/or for the users of the controller 10 or a group thereof, which—as already mentioned above—might be controlled by one of the data processing devices 8.

On a more abstract level the present invention mainly refers to two aspects:

a. providing a platform for providing web-based trainings T via Internet, and
b. controlling the web-based trainings T.

According to the second aspect the performance of the staff member S is dynamically monitored. It is possible to compare the actual performance with a target performance for the staff member S in the specific job situation. Thus, there is a target-actual comparison with respect to the training situation of the staff member.

Background of the present invention is the fact that each job has a specific job description and requires the successful completion of specific trainings T. The question, which specific trainings T out of the plurality of trainings have to be taken by the staff member S in a specific job situation is defined by guidelines. The guidelines might be adapted according to actual research effects and administrative requirements and might be stored in the guideline repository 16. For example a guideline might be: “A nurse working within an institution X has to participate in web trainings T₁, T₄, T₅”. Another guideline might be: “A surgeon has to participate in web trainings T₅, T₆, T₁₀ to T₁₅, and T₁₈”.

According to a preferred embodiment of the present invention there is provided an authentication module, which checks for the authorization and/or authentication of a user's access. For example, if the medical staff S might access web training The has to input a password and other authorization parameters in order to access the web training T. Additionally also authorization is required for the controlling user who accesses the controller 10.

According to a further embodiment of the present invention the controlling data of the controller 10 might be further processed for example by the human resource departments.

According to a further aspect of the present invention the method is carried out automatically.

Input of the system and the method according to the invention normally is the staff member data, which might be read in from the staff data repository 12, the training data, which might be stored in the training data repository 14, guideline data, which might be stored in the guideline data repository 16. Other embodiments contain further input data for example referring to the rules according to which the staff member wants to access a specific web-based training T. Other meta data might refer to time related data in order to answer questions like “In which sequence the web trainings have to be taken for the job specification?”, “Which kind of sequence for the web trainings T is required for a job specification?”, “How many years of practice are equivalent to the completion of web-based trainings?” and the like. Besides the suggestion an outcome of the method according to the invention might also be a reminder. The reminder might be a message in order to inform the staff member that he still has to take part in specific trainings T. In case the staff member still has to take part in trainings T and the trainings T have not yet been completed successfully or in case these trainings did not even start, it is possible to issue a non-execution message. The non-execution message might be issued by the central controller 10 and might be sent to the computer of the staff member S and additionally to other instances. With this feature it is possible to show and display all the deficiencies with regard to the training situation for a staff member S.

According to another preferred embodiment the controller 10 runs on a central server which is in communication with plurality of clients, like the data processing devices 8 the web repositories 14 for the web trainings T and with the other repositories 12, 14, 16 and additionally with other instances.

Usually all knowledge, how to assign a subset of trainings T to a specific job description is implemented in the guidelines. The guidelines might implement rules which are specific for the institution, so that hospital A might have other guidelines than hospital B. In another embodiment it is possible that the guidelines are not limited to any one institution, so that a job description is consistently and uniformly assigned to specific web-based trainings T, independently of the institution of the staff member S.

A major advantage of the present invention is to be seen in that it becomes very easy to organize all trainings for all staff members within an institution. Further, this organization might be automated. For each job description it is stored a target qualification profile for the staff member. After detection of the actual qualification profile of the staff member, the actual profile is compared to the target profile and in case there are detected deficiencies, a suggestion is given which trainings or subsets of trainings are to be taken by the staff member S, in order to condition and approximate the actual qualification profile with the target profile. Moreover, it is possible to provide further information, for example with respect to the costs for the staff member as well as for the suggested trainings T, the time periods in which it is possible to participate in the suggested web trainings T, the tutors for the web trainings T and the like.

According to an embodiment of the invention web browsers are used, which make it possible that the web trainings T are stored separately from the staff member related data, which might be stored in a separate database 12. Also the guidelines might be stored in a separate database 16, so that it is possible to modify only one of the before mentioned data sets without accessing the other databases.

Moreover, it is possible to define different requirements for accessing the databases and/or servers 10, 12, 14, 18. For example it might be defined that the web-based trainings and the respective repositories 14 are only accessible during daytime, whereas an administrator is free to access the controller 10 at any time and also during nighttime, so that the overall performance of the system might be optimized.

Another advantage is to be seen that the personal data of a staff member might be taken into account for assigning a subset of trainings or for deducing the suggestion for trainings to be taken by the staff member S. For example, it is automatically taken into account, that the staff member S is on holidays during a specific web-based training T, so that another training course has to be suggested.

According to a further embodiment of the invention it is possible to provide an Excel sheet with a subset of trainings which already have been completed successfully by the staff member S and additionally with a subset of trainings which still have to be taken by the staff member S. The Excel sheet might be provided after a pre-definable time period. Additionally in later stage only modifications with respect to the initial Excel sheet might be provided.

According to another aspect of the present invention there are defined roles for staff members S. So it is possible to assign a subset of trainings to a role of a staff member S or directly to the staff member S, having a specific job description. A role of the staff member might be, for example, “Nurse”, “Medical Surgeon”, and “Administrative Personal”.

The method and the system according to the invention might be used by a central training unit in order to control the training for all staff members in all institutions centrally without being limited to any one institution itself. For there is provided a client-server architecture or a web architecture it is not required that the clinics have to buy specific units, because it is possible to access all data via web access.

The content of the web-based trainings T is dynamically adaptable in order to contain different clinical workflows, different clinical guidelines and different parameters and guidelines being not limited to anyone institution, as well as quality standards, quality trainings and employee trainings and medical courses.

By accessing the central controller 10 it is possible to retrieve information for answering the question “Who as a staff member should participate in training A and who should participate in training B?”. Further it is possible to automatically provide a booking system for the web-based trainings T and to manage other organizational data with respect to the staff members S and the web-based trainings T.

Further, it is possible to outsource all services related to the training courses for the staff members T. Thus, the clinical institution is no longer responsible for this. There is provided a remote control of the administration of the training situation for the staff members.

Normally, there are similar structures for job requirements in different institutions, so that training related data from a first institution A might be transferred to a second institution B.

Further, due to the distributed system according to the invention it is possible that a clinical institution provides not only training courses T for internal use (i.e. for its staff members S) but also for external use (i.e. for staff members of other institutions).

As already mentioned above, at least the staff member related data is stored separately from the other data in a staff data repository 12. This has the advantage that all security related data (all data with respect to the employees, which generally have to be kept secret) might be encapsulated, in order to prevent misuse and unauthorized access to these data. Employee related data might refer to the name, the telephone number, the E-mail address, and the job description etc. of the staff member S.

Another advantage of the present approach according to the invention is to be seen in that all databases are automatically adapted in case there will be any new events. For example in case the staff member S has successfully completed a specific web-based training course T, this information will be stored automatically and all data in the repositories will be updated without any user interaction.

According to another more complex embodiment of the present invention there is provided an interconnection to a booking system. In case there is given a suggestion for training courses to be taken by the staff member it is possible that the staff member authorizes this suggestion by user interaction. For example by clicking a mouse tab, an event is generated which invokes methods so that this suggestion will be applied and optionally executed directly. Accordingly, the booking system is invoked with the parameters already chosen, so that the staff member S directly may book the suggested web training T.

Also it is possible that the suggestion for web trainings T contains a plurality of suggestions in order to cover alternatives for educational paths to be taken.

1. A computer-implemented method for centrally controlling web-based training courses for at least one of a plurality of staff members, wherein each of the staff members has a job description within at least one of a plurality of institutions, which comprises the steps of:
providing a set of different training courses, accessible by a staff member via an Internet interface;
providing a set of different job descriptions for the staff members;
assigning a subset of training courses to the job description, which have to be completed by the staff member with the job description, wherein the assigning is based on institution-specific guidelines;
executing the following steps automatically for controlling the training courses for at least one of the plurality of staff members:
recording the training courses which already have been completed successfully by the staff member;
matching recorded training courses with the subset of training courses assigned; and
deducing a suggestion of training courses to be taken by the staff member.

2. The method according to claim 1, which further comprising executing a control of the web-based training courses via a central server and the suggestion of training courses is accessible by a plurality of clients.

3. The method according to claim 1, which further comprises:
storing staff data referring to the staff members in a staff data repository;
storing training data in a training repository; and
storing guideline data in a guideline repository, and all of the repositories are remotely accessible via web interfaces.

4. The method according to claim 1, wherein the suggestion of training courses and the trainings courses are remotely accessible via a web-interface.

5. The method according to claim 1, wherein a content of a training course is one of institution specific and not limited to any one institution.

6. The method according to claim 1, wherein the suggestion of training courses is automatically adapted in case the staff member has an amended job description, the staff member works within another institution, or the guidelines for assigning the subset of training courses to the job description has changed.

7. The method according to claim 1, wherein the suggestion of training courses includes deficiency data, referring to all deficiencies with regard to the training courses for the staff member.

8. The method according to claim 1, which further comprises:
monitoring whether the suggestion of training courses deduced has been taken and if not:
reminding the staff member; and
issuing a non-execution message.

9. The method according to claim 1, wherein the suggestion of training courses includes one of planning data, referring to planned costs and needs investment of suggested trainings to be taken.

10. The method according to claim 1, wherein the assigning step includes providing a role model for each of the staff members.

11. The method according to claim 1, wherein the suggestion of training courses is one of automatically and semi-automatically incorporated into an electronic personal calendar of the staff member.

12. The method according to claim 1, wherein the suggestion of training courses differentiates between mandatory training courses and optional training courses.

13. The method according to claim 1, which further comprises providing at least one browser interface for the staff member to book, to administer and to participate in the training courses to be taken by him.

14. The method according to claim 1, wherein the training courses are healthcare related and the institution is one of a healthcare provider hospital, a network of hospitals, and medical practitioners.

15. The method according to claim 1, wherein for each of the job descriptions there is assigned a qualification profile, which is defined by the training courses which have to be completed successfully.

16. The method according to claim 1, wherein the set of training courses are one of to be taken in a pre-definable order and within pre-definable time periods.

17. The method according to claim 1, which further comprises storing the method on a computer readable medium.

18. A computer based controlling system for web-based training courses, comprising:
a plurality of data processing devices for staff members;
a plurality of web-based training courses accessible by said data processing devices of the staff members via an Internet interface;
a central controlling server for controlling the training courses for the staff members, said central controlling server being in communication with said data processing devices of the staff members and having an assigning instance which is adapted:
to record training courses which already have been successfully completed by the staff member;
to assign a subset of training courses to a job description of the staff member, the subset of training courses are incompleted courses to be completed by the staff member with the job description.

19. The system according to claim 18, wherein the training courses are assigned based on institution-specific guidelines.

20. The system according to claim 18, further comprising a plurality of repositories, the training courses being stored on different ones of said repositories.

21. The system according to claim 18, wherein the staff members work in different institutions, which may have different guidelines.

22. The system according to claim 18, wherein the staff members may access said central controlling server for one of booking training and receiving the subset of training courses assigned.

23. The system according to claim 18, wherein said central controlling server is part of at least one of a plurality of institutions and an electronically coupled separate instance.

24. A method for computer implemented administration and organization of training courses for staff members, which comprises the steps of:
generating and storing an actual qualification profile for each staff member being indicative of a qualification status of the staff members and contains a set of training courses;
providing a target qualification profile for each role or function a staff member could have and which is indicative of the target qualification status for the staff member, the target qualification profile containing a set of target qualifications for the role or the function;
deducing and storing for each training course out of the plurality of training courses which target qualifications might be acquired by the training course; and
deducing a suggestion of training courses to be taken by the staff member, taking into account the actual qualification profile and the target qualification profile to optimally match and align the actual qualification profile and the target qualification profile and further taking into account a role or function of the staff member, time-related parameters or financial parameters.
